(19) United States
(12) Patent Application Publication
(10) Pub. No.: US 2015/0009006 A1
(43) Pub. Date: Jan. 8, 2015

(54) TRANSFORMER

(71) Applicants: SAMSUNG ELECTRO-MECHANICS CO., LTD., Suwon (KR); INDUSTRY-ACADEMIC COOPERATION FOUNDATION GYEONGSANG NATIONAL UNIVERSITY, Jinju (KR)

(72) Inventors: Jong Hae KIM, Suwon (KR); Jae Sun WON, Suwon (KR); Young Min LEE, Suwon (KR); Hwi Beom SHIN, Jinju (KR); Se Kyo CHUNG, Jinju (KR); Sang Dae KIM, Suwon (KR)

(21) Appl. No.: 14/493,124

(22) Filed: Sep. 22, 2014

Related U.S. Application Data
(62) Division of application No. 13/678,137, filed on Nov. 15, 2012, now abandoned.

(30) Foreign Application Priority Data
Jul. 27, 2012 (KR) 10-2012-0082776

(51) Int. Cl. H01F 27/28; B29C 45/14; H01F 27/32

(52) U.S. Cl. CPC H01F 27/2823; H01F 27/32; B29C 45/14; B29L 2031/711
USPC 336/84 R; 336/199; 336/206; 264/272.19

(57) ABSTRACT

There is provided a transformer including: a bobbin; a primary coil member mounted in the bobbin; and a secondary coil member formed integrally with the bobbin.

### CROSS-REFERENCE TO RELATED APPLICATIONS

This application claims the priority of Korean Patent Application No. 10-2012-0082776 filed on Jul. 27, 2012, in the

Korean Intellectual Property Office, the disclosure of which is incorporated herein by reference.

### BACKGROUND OF THE INVENTION

1. Field of the Invention

The present invention relates to a transformer, and more particularly, to a transformer capable of being miniaturized and automatically produced.

2. Description of the Related Art

Generally, although a driving voltage required in an electronic device may be low, a voltage of external power supplied to the electronic device will be high. Therefore, the electronic device includes a transformer lowering a relatively high external voltage to a voltage required substantially.

The transformer includes first and second coils for voltage conversion, and the first and second coils are wound around a body of a bobbin to be fixed thereto. However, since it is difficult to automate this coil mounting structure, productivity of the transformer is deteriorated. Therefore, development of a coupling structure of the bobbin and coil capable of improving productivity of the transformer has been required.

Meanwhile, the coil should be covered with an insulation film in order to insulate between windings. However, since a coil of wire covered with an insulation film has a significant thickness, as compared to a coil of uncovered wire, a volume of the transformer is increased, such that it may be difficult to miniaturize the transformer.

As related art for improving insulation performance of the coil, there is provided the following Related Art Document. According to the following Related Art Document, a coil block is covered with a mold layer, such that insulation performance of the coil block may be improved.

However, in the following Related Art Document, the coil block is manually formed, such that it is difficult to improve productivity of the transformer.

[Related Art Document]

JP2011-134873 A

### SUMMARY OF THE INVENTION

An aspect of the present invention provides a transformer capable of being miniaturized and automatically produced.

According to an aspect of the present invention, there is provided a transformer including: a bobbin; a primary coil member mounted in the bobbin; and a secondary coil member formed integrally with the bobbin.

The bobbin may be provided with a groove corresponding to the second coil member, and the second coil member may be inserted into the groove.

The secondary coil member may be formed integrally with the bobbin by insert injection molding.

The secondary coil may be formed by press processing of a copper plate.

The secondary coil member may include a first secondary coil member formed on one end of the bobbin and a second secondary coil member formed on the other end of the bobbin, and the primary coil member may be mounted between the first and second secondary coil members.

The transformer may further include an auxiliary coil member mounted in the bobbin.

The auxiliary coil member may include: an insulating plate including a groove formed in one surface thereof; and an auxiliary coil inserted into the groove.

The secondary coil member may further include a shielding member.

The shielding member may be formed integrally with the bobbin by insert injection molding.

According to another aspect of the present invention, there is provided a transformer including: a bobbin including a receiving space; a primary coil member mounted in the bobbin; and a secondary coil member mounted in the receiving space.

The secondary coil member may include: an insulating plate including a groove formed therein; and a secondary coil inserted into the groove.

The secondary coil member may include: an insulating plate; and a secondary coil formed integrally with the insulating plate by insert injection molding.

The secondary coil may be formed by press processing of a copper plate.

The transformer may further include an auxiliary coil member mounted in the bobbin.

The auxiliary coil member may include: an insulating plate including a groove formed in one surface thereof; and an auxiliary coil inserted into the groove.

The secondary coil member may further include a shielding member.

The secondary coil member may include an insulating plate including a groove formed in one surface thereof and a secondary coil inserted into the groove, and the shielding member is attached to the other surface of the insulating plate.

According to another aspect of the present invention, there is provided a transformer including: a bobbin formed by coupling a plurality of bobbin members to each other; a primary coil wound around the bobbin; and a secondary coil formed integrally with the bobbin member.

The secondary coil may be formed integrally with the bobbin member by insert injection molding.

The bobbin may include: a first bobbin member; and at least one second bobbin member coupled to the first bobbin member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a separated perspective view showing main components of a transformer according to an embodiment of the present invention;

FIGS. 2 and 3 are perspective views showing a secondary coil shown in FIG. 1;

FIG. 4 is an assembly perspective view of the transformer shown in FIG. 1;

FIG. 5 is a cross-sectional view taken along line A-A of the transformer shown in FIG. 4;

FIG. 6 is a cross-sectional view showing main components of a transformer according to another embodiment of the present invention;

FIG. 7 is a cross-sectional view showing a separated state of a transformer according to another embodiment of the present invention;

FIG. 8 is a cross-sectional view showing a combined state of a bobbin shown in FIG. 7;

FIG. 9 is a separated perspective view of a transformer according to another embodiment of the present invention;

FIG. 10 is an assembly perspective view of the transformer shown in FIG. 9;

FIG. 11 is a cross-sectional view of the transformer shown in FIG. 10;

FIG. 12 is a separated perspective view of a transformer according to another embodiment of the present invention;

FIG. 13 is an assembly perspective view of the transformer shown in FIG. 12; and

FIG. 14 is a cross-sectional view of the transformer shown in FIG. 13.

### DETAILED DESCRIPTION OF THE EMBODIMENTS

A transformer may include a bobbin, a coil, and a core. Since the coil among these components is a component wound around a body of the bobbin through manual handling or the like, it may be difficult to automate a process of winding the coil around the bobbin. In addition, since it is difficult to wind the coil around the bobbin at a uniform density, it may be difficult to standardize and miniaturize the transformer.

Therefore, according to an embodiment of the present invention, a coil mounted in the bobbin may be modulated or formed integrally with a bobbin, productivity and miniaturization of the transformer may be implemented.

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

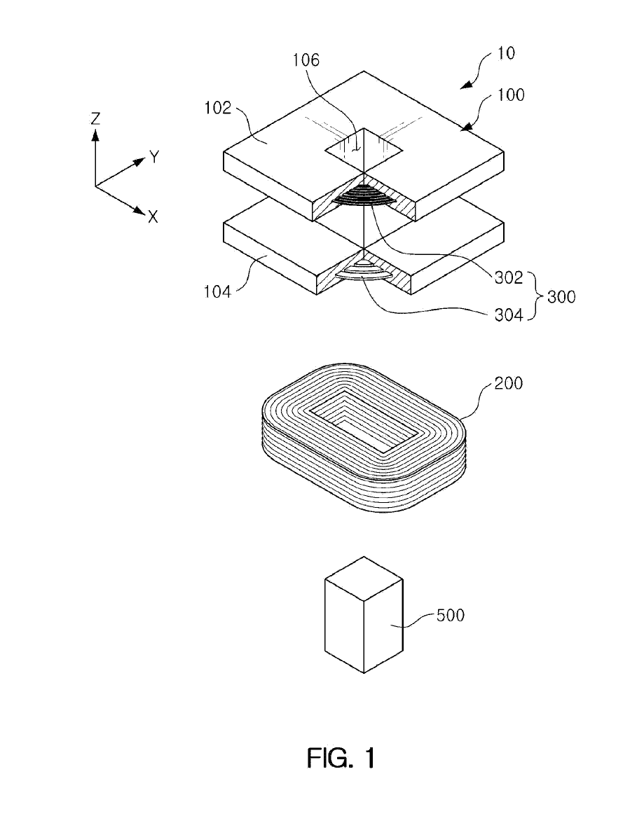

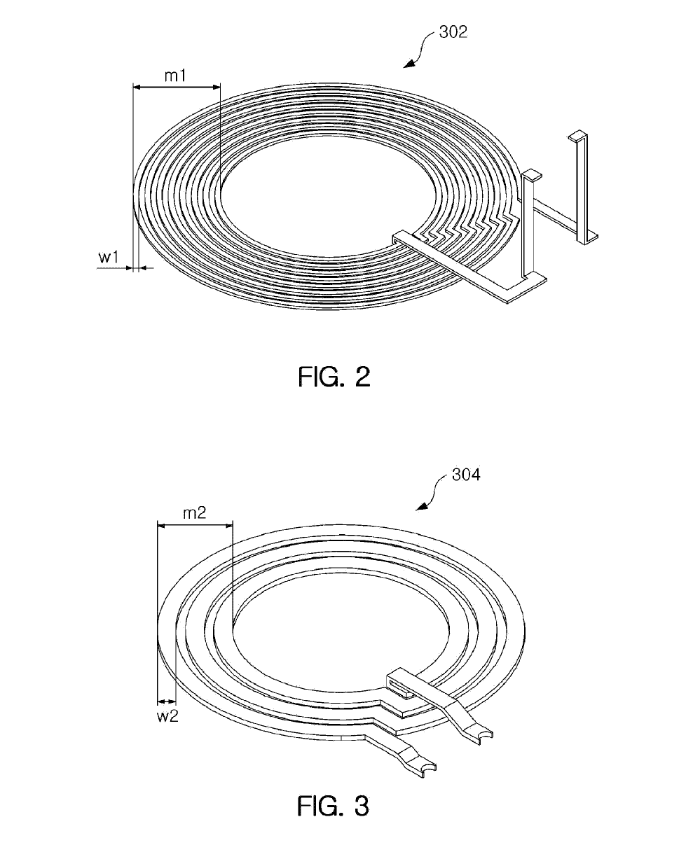

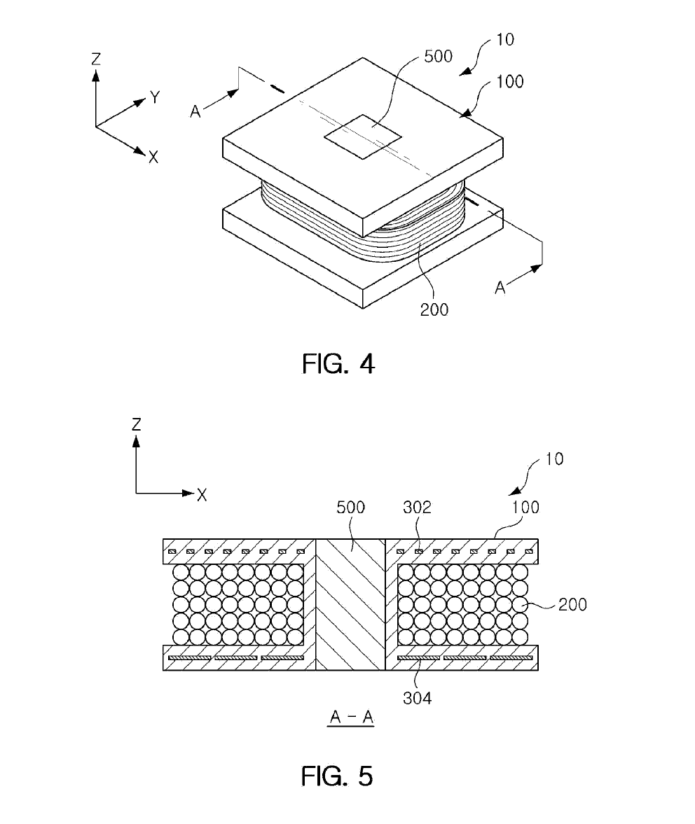

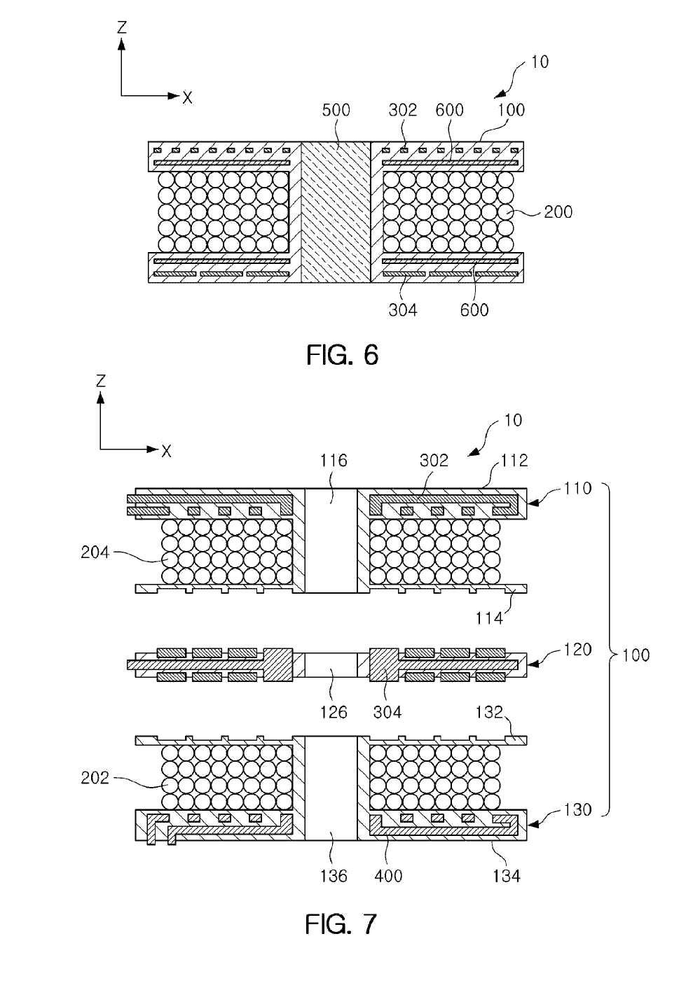

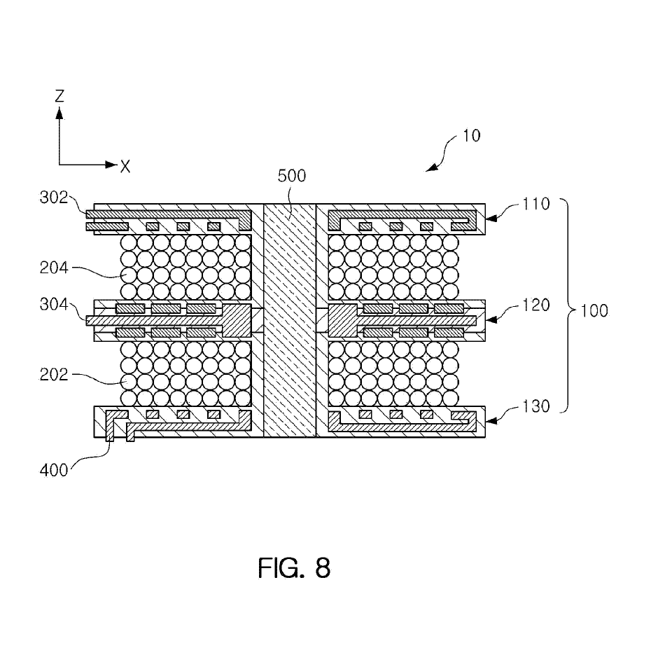

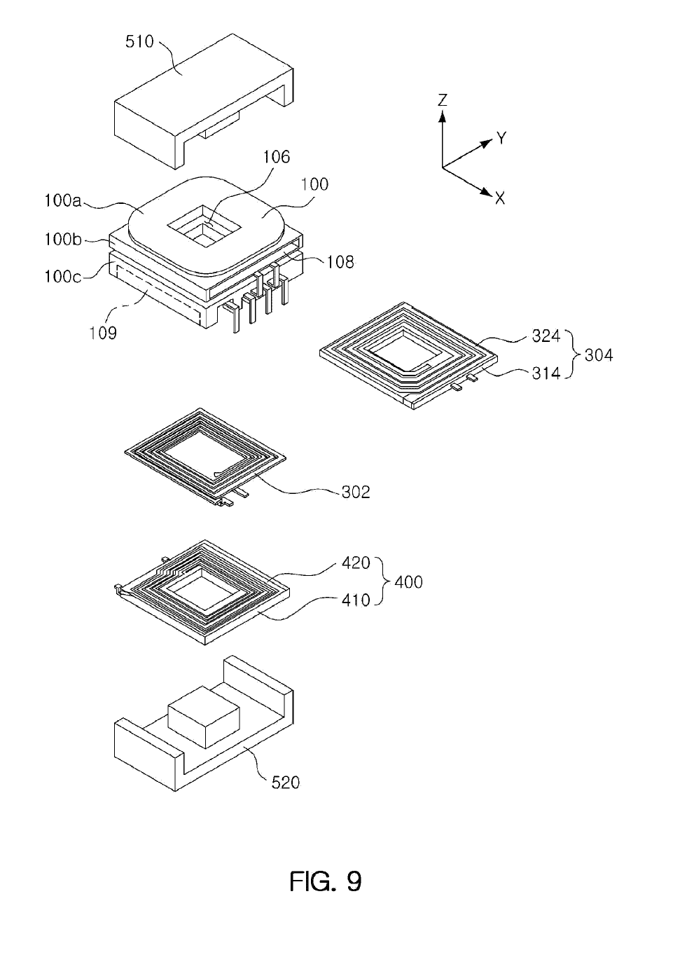

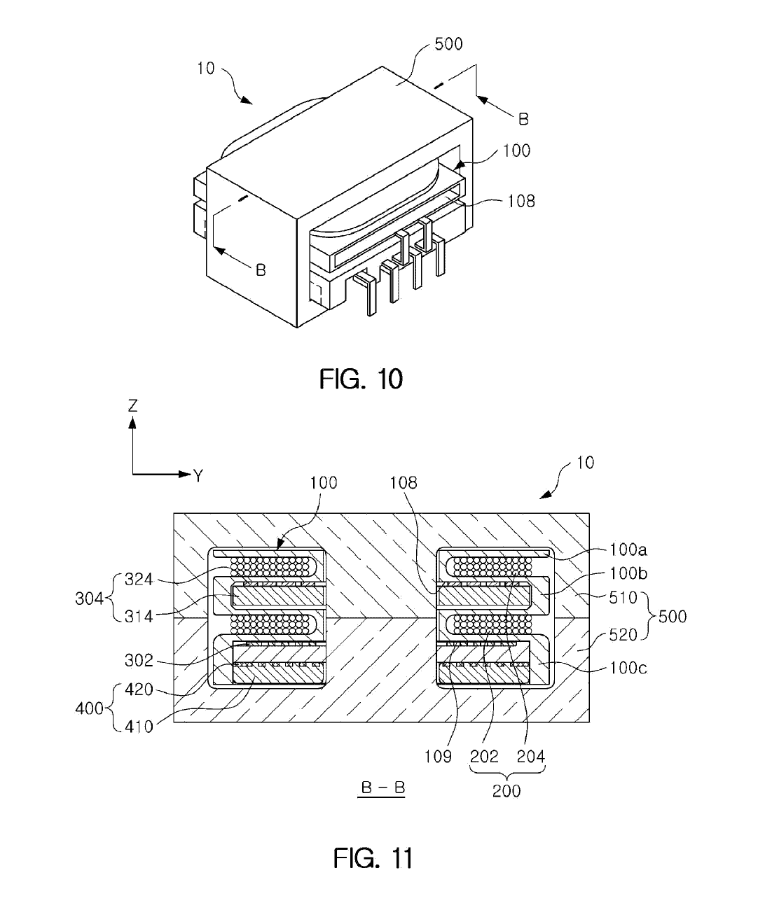

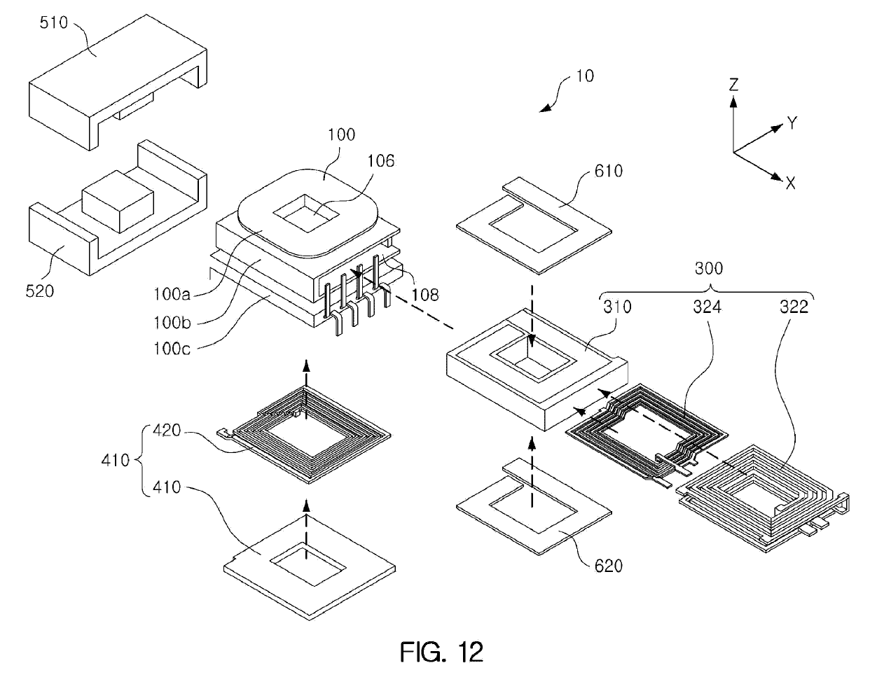

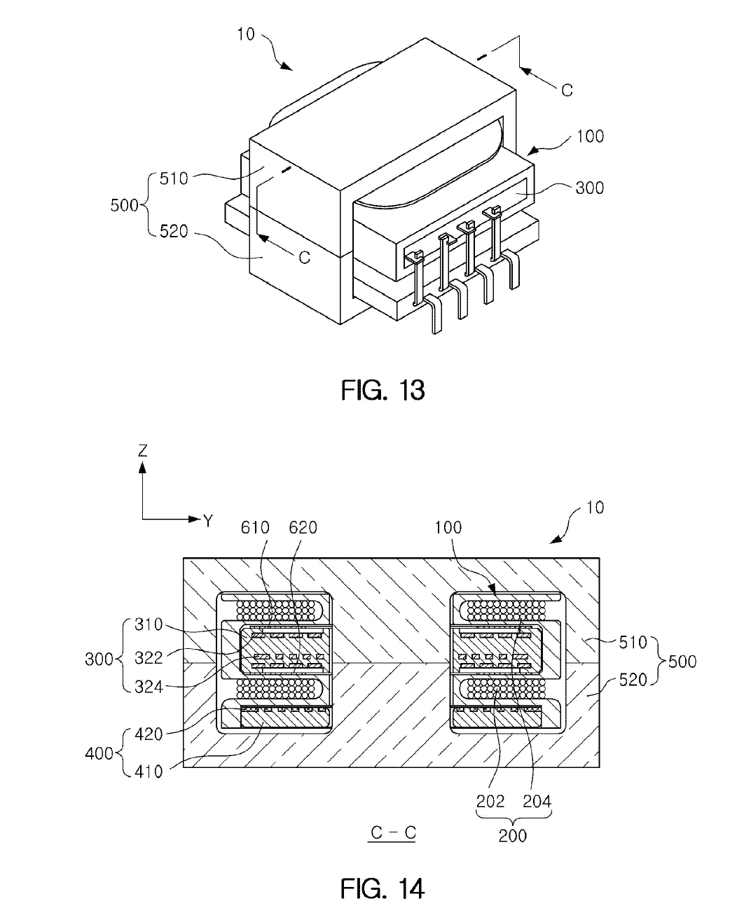

FIG. 1 is a separated perspective view showing main components of a transformer according to an embodiment of the present invention; FIGS. 2 and 3 are perspective views showing a secondary coil shown in FIG. 1; FIG. 4 is an assembly perspective view of the transformer shown in FIG. 1; FIG. 5 is a cross-sectional view taken along line A-A of the transformer shown in FIG. 4; FIG. 6 is a cross-sectional view showing main components of a transformer according to another embodiment of the present invention; FIG. 7 is a cross-sectional view showing a separated state of a transformer according to another embodiment of the present invention; FIG. 8 is a cross-sectional view showing a combined state of a bobbin shown in FIG. 7; FIG. 9 is a separated perspective view of a transformer according to another embodiment of the present invention; FIG. 10 is an assembly perspective view of the transformer shown in FIG. 9; FIG. 11 is a cross-sectional view of the transformer shown in FIG. 10; FIG. 12 is a separated perspective view of a transformer according to another embodiment of the present invention; FIG. 13 is an assembly perspective view of the transformer shown in FIG. 12; and FIG. 14 is a cross-sectional view of the transformer shown in FIG. 13.

The transformer according to the embodiment of the present invention will be described with reference to FIGS. 1 through 5.

The transformer 10 may include a bobbin 100, a primary coil member 200, a secondary coil member 300, and a core 500.

The bobbin 100 may have a bar shape in which the bobbin is extended lengthwise in a first direction (a Z axis direction based on FIG. 1). In addition, flat surfaces parallel with an X-Y plane may be formed on one end 102 and the other end 104 of the bobbin 100. These flat surfaces may block the primary coil member 200 from being separated from a body of the bobbin 100.

A penetrating hole 106 extended in a lengthwise direction of the bobbin 100 (the Z axis direction based on FIG. 1) may be formed in the bobbin 100. The core 500 forming a magnetic path may be inserted into the penetrating hole 106. The penetrating hole 106 may be formed in a central portion of the bobbin 100 (a direction based on the X-Y plane).

The primary coil member 200 may include a thin wire or a steel wire. More specifically, the primary coil member may be a coil bundle formed by winding one strand or two or more strands of the steel wire in a clockwise or counterclockwise direction. Here, the thin wire or the steel wire may be formed of a conductive material (for example, copper) and be covered with an insulating material, as needed. Meanwhile, the number of strands of the primary coil member 200 and winding turns thereof may be changed according to a type of transformer or winding turns of the secondary coil member 300.

The secondary coil member 300 may be formed on one end 102 or the other end 104 of the bobbin 100 or formed on both of one end 102 and the other end 104 of the bobbin 100.

The secondary coil member 300 may be formed integrally with the bobbin 100 as shown in FIG. 1. More specifically, the secondary coil member 300 may be formed integrally with the bobbin 100 inside the bobbin by a process such as insert injection molding, or the like. However, both ends of the secondary coil member 300 may be exposed to the outside of the bobbin 100 in order to be connected to an external circuit.

Since the secondary coil member 300 formed as described above is insulated from the outside by the bobbin 100, there is no need to be covered with an insulation member. Therefore, according to the embodiment of the present invention, volume of the secondary coil member 300 may be significantly reduced.

Meanwhile, according to the embodiment of the present invention, the secondary coil member 300 may be configured of a first secondary coil member 302 and a second secondary coil member 304. The first secondary coil member 302 may be formed on one end 102 of the bobbin 100, and the second secondary coil member 304 may be formed on the other end 104 thereof.

The secondary coil member 300 (302 and 304) maybe formed of a thin plate having a predetermined thickness as shown in FIGS. 2 and 3. That is, the secondary coil member 300 (302 and 304) may be formed by press-processing the thin plate. Here, a width w1 of the first secondary coil member 302 and a width w2 of the second secondary coil member 304 maybe different from each other. In addition, winding turns n1 of the first secondary coil member 302 and winding turns n2 of the second secondary coil member 304 may be different from each other. For reference, in the present embodiment, the winding turns of the first secondary coil member 302 is 8, and winding turns of the second secondary coil member 304 is 3.

Since the secondary coil member 300 (302 and 304) formed of the thin plate as described above may be easily manufactured through automation, productivity of the transformer 10 may be improved. In addition, since the secondary coil member 300 (302 and 304) formed of the thin plate may have a formularized shape, it may be easy to integrate the secondary coil member 300 with the bobbin 100 through the insert injection molding as described above.

The core 500 may be inserted into the penetrating hole 106 of the bobbin 100 and form the magnetic path. The core 500 may have a shape corresponding to that of the penetrating hole 106 and be formed of a conductive material. However, the shape and the material of the core 500 are not limited thereto and may be changed as needed.

The transformer 10 configured as described above may have a shape shown in FIG. 4. Since this transformer 10 has a structure in which only the primary coil member 200 is wound around the bobbin 100, the transformer 10 may be relatively thin.

Further, in the transformer 10, a distance between the primary coil member 200 and the secondary coil member 300 (302 or 304) may be significantly reduced as shown in FIG. 5, such that leakage inductance may be significantly reduced. Therefore, the transformer 10 may be usefully used in an electronic device requiring relatively small leakage inductance.

Meanwhile, although the case in which the secondary coil member 300 is disposed inside the bobbin 100 by the insert injection molding is described in the present embodiment, the secondary coil member 300 (302 and 304) may be integrated with the bobbin 100 by another method. For example, grooves may be formed in one end 102 and the other end 104 of the bobbin 100, respectively, and the first and second primary coil members 302 and 304 may be inserted into the corresponding grooves, respectively.

Hereinafter, a transformer according to another embodiment of the present invention will be described. For reference, hereinafter, the components described in the embodiment will be denoted by the same reference numerals and a description thereof will be omitted.

The transformer according to another embodiment of the present invention will be described with reference to FIG. 6.

The transformer 10 according to another embodiment of the present invention may be differentiated from that of the embodiment of the present invention in that the transformer 10 further includes a shielding member 600.

The shielding member 600 may have a plate shape and be formed integrally with the bobbin 100 similarly to secondary coil members 302 and 304. That is, the shielding member 600 may be formed inside a bobbin 100 by insert injection molding. However, as needed, the shielding member 600 may be disposed between a primary coil member 200 and the secondary coil members 302 and 304.

In the transformer 10 configured as described above, since the separate shielding member 600 is disposed between the primary coil member 200 and the secondary coil members 302 and 304, external electromagnetic wave interference may be effectively blocked.

A transformer according to another embodiment of the present invention will be described with reference to FIGS. 7 and 8.

The transformer 10 according to the embodiment of the present invention may be differentiated from those of the above-mentioned embodiments in a structure of the bobbin 100.

The bobbin 100 according to the present embodiment may be configured of a plurality of members. For example, the bobbin 100 may be configured of a first bobbin member 110, a second bobbin member 120, and a third bobbin member 130. These bobbin members 110, 120, and 130 maybe separated from each other and be coupled to each other. To this end, the bobbin members 110, 120, and 130 may include separate coupling units (for example, protrusions or grooves). Alternatively, the bobbin members 110, 120, and 130 may be adhered by an adhesive.

The first bobbin member 110 may include a first plate shaped part 112 and a second plate shaped part 114. The first and second plate shaped parts 112 and 114 may include a second primary coil member 204 wound therebetween. The first and second plate shaped parts 112 and 114 may have predetermined thicknesses and be formed on both ends of the first bobbin member 110. The first plate shaped part 112 may include a first secondary coil member 302 therein. The first secondary coil member 302 may be formed integrally with the first plate shaped part 112 by insert injection molding. The second plate shaped part 114 may have a form in which it is coupled to one surface of the second bobbin member 120. To this end, the second plate shaped part 114 may include a plurality of protrusions or grooves formed therein. Meanwhile, the first bobbin member 110 may include a first penetrating hole 116 formed therein so that a core 500 may be inserted thereinto.

The second bobbin member 120 may have a plate shape. The second bobbin member 120 may include a second penetrating hole 126 formed therein so as to be connected to the first penetrating hole 116. One surface and the other surface of the second bobbin member 120 may be provided with the second secondary coil member 304. The second secondary coil member 304 may be formed integrally with the second bobbin member 120 by insert injection molding.

The third bobbin member 130 may include a first plate shaped part 132 and a second plate shaped part 134. The first and second plate shaped parts 132 and 134 may include a first primary coil member 202 wound therebetween. The first and second plate shaped parts 132 and 134 may have predetermined thicknesses and be formed on both ends of the third bobbin member 130. The first plate shaped part 132 may have a form in which it is coupled to the other surface of the second bobbin member 120. To this end, the first plate shaped part 132 may include a plurality of protrusions or grooves formed therein. The second plate shaped part 134 may include an auxiliary coil member 400 formed therein. The auxiliary coil member 400 may be formed integrally with the second plate shaped part 134 through insert injection molding. Meanwhile, the third bobbin member 130 may include a third penetrating hole 136 formed therein so that the core 500 may be inserted thereinto.

In the transformer 10 configured as described above, the secondary coil members 302 and 304 and the auxiliary coil member 400 are formed integrally with the bobbin members 110, 120, and 130 that may be separated or coupled, respectively, which may be suitable for manufacturing and producing the transformer 10 including the plurality of coil members 202, 204, 302, 304, and 400.

A transformer according to another embodiment of the present invention will be described with reference to FIGS. 9 through 11.

The transformer 10 according to the embodiment of the present invention may be differentiated from those of the above-mentioned embodiments in shapes of a bobbin 100 and coil members.

The bobbin 100 according to the present embodiment may include a first plate shaped part 100a, a second plate shaped part 100b, and a third plate shaped part 100c. Here, the second and third plate shaped parts 100b and 100c may have significant thickness so as to receive the coil members therein.

The bobbin 100 may include a first receiving space 108 and a second receiving space 109. The first receiving space 108 may be formed in the second plate shaped part 100b and be opened in a side direction of the bobbin 100 (in a positive X direction based on FIG. 9). The first receiving space 108 may have a size in which a second secondary coil member 304 can be received therein. The second receiving space 109 may be formed in the third plate shaped part 100c and be opened in a direction downward of the bobbin 100 (in a negative Z direction based on FIG. 9). The second receiving space 109 may have a size in which a first secondary coil member 302 and an auxiliary coil member 400 may be received therein.

Meanwhile, the second primary coil member 204 may be wound between the first plate shaped part 100a and the second plate shaped part 100b, and a first primary coil member 202 may be wound between the second plate shaped part 100b and the third plate shaped part 100c (See FIG. 11).

The first secondary coil member 302 may be a metal thin plate cut in a coil shape. The first secondary coil member 302 formed as described above may be mounted in the second receiving space 109.

The second secondary coil member 304 may include an insulating plate 314 and a second secondary coil 324. The insulating plate 314 may include a groove formed therein so as to correspond to a shape of the second secondary coil 324, wherein a corresponding groove thereof may have the second secondary coil 324 inserted therein. However, as needed, the insulating plate 314 and the second secondary coil 324 may be formed integrally with each other by insert injection molding. The second secondary coil 324 may be formed of a thin plate. For example, the second secondary coil 324 may be formed by press processing the thin plate in a coil shape. The second secondary coil member 304 formed as described above may be inserted into the first receiving space 108 in a sliding method.

The auxiliary coil member 400 may include an insulating plate 410 and an auxiliary coil 420. The insulating plate 410 may include a groove formed therein so as to correspond to a shape of the auxiliary coil 420. A corresponding groove may have the auxiliary coil 420 inserted therein. However, as needed, the insulating plate 410 and the auxiliary coil 420 may be formed integrally with each other by insert injection molding. The auxiliary coil 420 may be formed of a thin plate. For example, the auxiliary coil 420 may be formed by press processing the thin plate in a coil shape. The auxiliary coil member 400 configured as described above may be inserted in the second receiving space 109.

A core 500 may be configured of a first core member 510 and a second core member 520. The first core member 510 may be inserted into an upper portion of the bobbin 100, and the second core member 520 may be inserted in a lower portion thereof. The first and second core members 510 and 520 may forma magnetic path by being connected in a state in which the first and second core members 510 and 520 are coupled to the bobbin 100.

In the transformer 10 configured as described above, since the secondary coil members 302 and 304 and the auxiliary coil member 400 may be respectively manufactured to have a modular form to be mounted in the bobbin 100, a manufacturing process of the transformer 10 may be simplified and automated.

The transformer according to another embodiment of the present invention will be described with reference to FIGS. 12 through 14.

The transformer 10 according to the embodiment of the present invention may be differentiated from that of the foregoing embodiment in a structure of a secondary coil member 300.

The secondary coil member 300 according to the present embodiment may include an insulating plate 310 and secondary coils 322 and 324. The insulating plate 310 may have a size approximately corresponding to that of a first receiving space 108.

The second coils 322 and 324 may be formed inside the insulating plate 310. That is, the second coils 322 and 324 maybe formed integrally with the insulating plate 310 by insert injection molding. The secondary coils 322 and 324 may be configured of a first secondary coil 322 and a second secondary coil 324. Here, the first and second secondary coils 322 and 324 may be formed of a plate member and have different winding turns from each other.

Shielding members 610 and 620 may be attached to upper and lower surfaces of the secondary coil member 300, respectively. To this end, the upper and lower surfaces of the secondary coil member 300 may be provided with grooves corresponding to shapes of the shielding members 610 and 620.

In the transformer 10 configured as described above, since each of the secondary coil member 300 and the auxiliary coil member 400 is manufactured to have a modular form, a manufacturing process of the transformer 10 may be simplified.

As set forth above, according to the embodiments of the present invention, the transformer may be miniaturized while improving insulation between the coils.

In addition, according to the embodiments of the present invention, a coupling structure between the coil and the bobbin may be simplified, such that production of the transformer may be automated.

While the present invention has been shown and described in connection with the embodiments thereof, it will be apparent to those skilled in the art that modifications and variations can be made without departing from the spirit and scope of the invention as defined by the appended claims.

1-5. (canceled)

6. The transformer comprising:
a bobbin;
a primary coil member mounted in the bobbin; and
a secondary coil member formed integrally with the bobbin further comprising an auxiliary coil member mounted in the bobbin.

7. The transformer of claim 6, wherein the auxiliary coil member includes:
an insulating plate including a groove formed in one surface thereof; and
an auxiliary coil inserted into the groove.

8. The transformer of claim 6, wherein the secondary coil member further includes a shielding member.

9. The transformer of claim 8, wherein the shielding member is formed integrally with the bobbin by insert injection molding.

10. A transformer comprising:
a bobbin including a receiving space;
a primary coil member mounted in the bobbin; and
a secondary coil member mounted in the receiving space.

11. The transformer of claim 10, wherein the secondary coil member includes:
an insulating plate including a groove formed therein; and
a secondary coil inserted into the groove.

12. The transformer of claim 10, wherein the secondary coil member includes:
an insulating plate; and
a secondary coil formed integrally with the insulating plate by insert injection molding.

13. The transformer of claim 12, wherein the secondary coil is formed by press processing of a copper plate.

14. The transformer of claim 12, further comprising an auxiliary coil member mounted in the bobbin.

15. The transformer of claim 14, wherein the auxiliary coil member includes:
an insulating plate including a groove formed in one surface thereof; and
an auxiliary coil inserted into the groove.

16. The transformer of claim 10, wherein the secondary coil member further includes a shielding member.

17. The transformer of claim 16, wherein the secondary coil member includes an insulating plate including a groove formed in one surface thereof and a secondary coil inserted into the groove, and
the shielding member is attached to the other surface of the insulating plate.

18. A transformer comprising:
a bobbin formed by coupling a plurality of bobbin members to each other;
a primary coil wound around the bobbin; and
a secondary coil formed integrally with the bobbin member.

19. The transformer of claim 18, wherein the secondary coil is formed integrally with the bobbin member by insert injection molding.

20. The transformer of claim 18, wherein the bobbin includes:
a first bobbin member; and
at least one second bobbin member coupled to the first bobbin member.
